(19) United States
(12) Patent Application Publication
(10) Pub. No.: US 2016/0198454 A1
(43) Pub. Date: Jul. 7, 2016

(54) SYSTEMS AND METHODS FOR AD HOC CELLULAR COMMUNICATIONS

(71) Applicant: Andrew Jay Diamond, Marietta, GA (US)

(72) Inventor: Andrew Jay Diamond, Marietta, GA (US)

(21) Appl. No.: 15/069,448

(22) Filed: Mar. 14, 2016

Related U.S. Application Data
(63) Continuation-in-part of application No. 13/732,969, filed on Jan. 2, 2013.
(60) Provisional application No. 61/631,438, filed on Jan. 5, 2012.

(51) Int. Cl. H04W 72/04; H04W 4/02; H04W 72/06; H04L 29/08

(52) U.S. Cl. CPC H04W 72/048; H04L 67/306; H04W 4/025; H04W 72/06; H04W 84/18

(57) ABSTRACT

Systems and methods for enabling communications between individuals based on the roles of the individuals and establishing that role by the behavior of the individual. Generally, a smartphone application gathers information regarding its users to determine the users' roles. In various embodiments, the automatically generated roles of the users within the community permit the application to enable anonymous communications between users based on the role of the users.

### CROSS REFERENCE TO RELATED APPLICATIONS

This application claims priority to, is a continuation-in-part of, and incorporates by reference herein in its entirety U.S. Non-Provisional patent application Ser. No. 13/732,969, filed Jan. 2, 2013, and entitled “Method and System for AD HOC Cellular PBX,” which in turn claims priority to and the benefit under 35 U.S.C. §119 of U.S. Provisional Patent Application No. 61/631,438, filed Jan. 5, 2012, and entitled “Method and System for AD HOC Application Centrix PBX.”

### TECHNICAL FIELD

The present systems and methods relate generally to cellular communication and, more particular, to systems and methods that permit communications between individuals based on the roles of the individuals and that establish that role based (at least in part) on the behavior of the individuals.

### BACKGROUND

Smartphones are increasing the connectivity between individuals and providing ever expanding amounts of information regarding their users. Generally, however, smartphones only permit connections between individuals with prior relationships. For example, to call a repairman to fix a leak in a house, the home owner must first determine that repairman's telephone number. Moreover, the smartphone, while it gathers massive amounts of information, generally does not provide any identification of its user based on that information. For example, a smartphone may gather time-stamped location data regarding its users as they move from location to location with their smartphones. Thus, even though a waiter may have his/her smartphone on his/her person while waiting tables and the smartphone is recording that location data, the smartphone cannot currently identify its user as a waiter based solely on that location data.

Therefore, there is a long-felt but unresolved need for a system or method that permits communications between individuals based on the roles of the individuals and that establishes that role based (at least in part) on the behavior of the individuals.

### BRIEF SUMMARY OF THE DISCLOSURE

Briefly described, and according to one embodiment, aspects of the present disclosure generally relate to systems and methods for enabling communications between individuals based on the roles of the individuals and establishing that role based (at least in part) on the behavior of the individuals.

Generally, smartphone users download an application with functionality corresponding to the present disclosure. That application permits users to form communities based on a central topic for which they may have a common affinity or association (e.g., a particular breed of dogs, conference at which the users are attending, restaurant at which the users are dining, private club, sporting event/team, physical or geographic location, neighborhood, etc.). When connected to these communities, the smartphones gather information regarding the users to determine the users' roles within the community so that a user does not need to define their role within the community and so that other users can accurately contact other users within the community that have a certain role. Generally, by automatically defining a user's role, the communities may not need an administrator to manage users within the community (e.g., as new users are added, as users change roles, etc.). For example, in a restaurant-based community that contains users who are patrons of the restaurant, staff of the restaurant, owners of the restaurant, etc., Bluetooth® beacons may be placed at each table so that location data may be gathered regarding the users to establish a user's role within the restaurant-based community (e.g., patron, manager, waiter, etc.). Continuing with this example, a waiter may be identified because the smartphone constantly moves from table to table (e.g., constantly passing multiple Bluetooth® beacons). Similarly, a user who is constantly interacting with the waiters (e.g., meeting with them in a particular room, answering their questions within the community, etc.) may be identified as a manager of the restaurant. Further, a user who was previously identified as a patron may be re-identified as a waiter if the user begins to constantly move from table to table.

In various embodiments, the automatically generated/identified/defined roles of the users within the community permit the application to enable various functionality, such as anonymous communications between users based on the role of the users (e.g., no contact information or names need to be provided to the users). Generally, this permits a user to receive information from another user based on the type of information the user wants to receive without requiring multiple attempts to find the appropriate user to provide that information. For example, a patron may need to speak with a manager regarding a complaint about a waiter; thus, the patron may indicate, within the application, that the user wants to speak with a manager and will be connected to a manager without first needing to know the identity of that manager or asking the waiter to speak with the manager. Similarly, at a conference, a user may contact a particular type of vendor (e.g., office machines, etc.) without needing to know which specific vendors are at the conference or the types of equipment those vendors provide. Based on the identified roles, the system may generate multiple different metrics such as a heat map that shows the types of communications occurring on the system based on the roles of the users making those communications, the amount of time a user is active within a particular location, etc.

In one embodiment, the application initiates at the request of a user or when the user enters a particular location. Based on the user's profile information and access permissions granted by the user within the smartphone, the application determines the appropriate community in which to place the user. The application then generates a page with relevant information regarding the community, based on that user's role within the same, to present to the user. Within the community, the user may communicate with other users, navigate between pages, request information, etc. Generally, the application facilitates any action that the user wishes to take.

In one embodiment, a method, comprising the steps of: receiving a request from a particular electronic device to contact a particular type of user of another electronic device, wherein the request comprises one or more electronic data items that define criteria for identifying the particular type of user; comparing the one or more electronic data items to one or more user profiles associated with system users to identify one or more system users whose profiles match, at least in part, the criteria defined in the request and the particular type of user; retrieving connection information for each of the identified one or more users, wherein the connection information comprises an availability for contact for each of the identified one or more users and contact information associated with each of the identified one or more users; determining, based on the connection information, a specific user to contact; and establishing a connection, based on the contact information, between the particular electronic device and an electronic device of the specific user.

In one embodiment, system, comprising: a first electronic device that generates a request to contact a particular type of user of another electronic device, wherein the request comprises one or more electronic data items that define criteria for identifying the particular type of user, and transmits that request to a server; the server that receives that request from the first electronic device, wherein the server compares the one or more electronic data items to one or more user profiles associated with system users to identify one or more system users whose profiles match, at least in part, the criteria defined in the request and the particular type of user, generates a request for connection information regarding the identified one or more users, and transmits the request for connection information to a database; the database that receives the request for connection information from the server, wherein the database transmits, to the server, the connection information regarding the identified one or more users that comprises an availability for contact for each of the identified one or more users and contact information associated with each of the identified one or more users; the server that receives the connection information from the database, wherein the server determines, based on the connection information, a specific user to contact and establishes a connection, based on the contact information, between the first electronic device and a second electronic device corresponding to the specific user; and the second electronic device that connects with the first electronic device.

In one embodiment, a method, comprising the steps of: receiving location data from a particular electronic device, the location data defining one or more physical locations of the particular electronic device over a defined time period; comparing the received location data to one or more predefined rules, wherein the one or more predefined rules define one or more roles based on movement or non-movement of the particular electronic device as defined by the one or more physical locations of the particular electronic device over the defined time period; determining one or more roles corresponding to the particular electronic device; and associating the particular electronic device with the one or more determined roles.

In one embodiment, a system, comprising: an electronic device that gathers location data, wherein the location data comprises data defining one or more physical locations of the electronic device over a defined time period, and transmits the location data to a server; and the server that receives the location data from the electronic device, wherein the server compares the location data to one or more predefined rules that define one or more roles based on movement or non-movement of the electronic device as defined by the one or more physical locations of the electronic device over the defined time period, determines one or more roles corresponding to the electronic device, and associates the electronic device with the one or more determined roles.

According to one aspect of the present disclosure, the method, further comprising the steps of: requesting one or more electronic location data items corresponding to the physical location of the particular electronic device; receiving the one or more electronic location data items; determining, based on the received one or more electronic location data items, the physical location of the particular electronic device; transmitting, based on the contact information, the physical location of the particular electronic device to the electronic device of the specific user. Furthermore, the method, wherein the one or more electronic location data items further comprise two or more electronic location data items corresponding to the physical location of the particular electronic device. Moreover, the method, further comprising the steps of: receiving, as part of the connection, one or more electronic message data items corresponding to a message for the specific user; storing the one or more electronic message data items until receipt of a request from the specific user; transmitting, based on the contact information, the one or more electronic message data items to the electronic device of the specific user. Further, the method, wherein the identity of the specific user is unbeknownst to the particular electronic device prior to receiving the request. Additionally, the method, wherein the criteria for identifying the particular type of user and the one or more user profiles further comprise physical location data that matches. Also, the method, wherein the criteria for identifying the particular type of user further comprise one or more role parameters and the one or more user profiles further comprise one or more roles that match the one or more role parameters.

According to one aspect of the present disclosure, the method, wherein the criteria for identifying the particular type of user further comprise an affinity for a subject matter and the one or more roles further comprise the subject matter. Furthermore, the method, wherein the one or more roles are defined based on movement of electronic devices. Moreover, the method, wherein each of the one or more roles corresponds to a particular pattern of movement of electronic devices. Further, the method, wherein the particular pattern of movement of electronic devices corresponds to a defined time period. Additionally, the method, wherein determining, based on the connection information, a specific user to contact is further based on a priority of the identified one or more users defined by one or more predefined rules. Also, the method, wherein the connection is of a predefined type defined by the request, the contact information, or the one or more user profiles.

According to one aspect of the present disclosure, the system, wherein the server, as part of the connection: receives, from the first electronic device, one or more electronic message data items corresponding to a message for the specific user; and stores the one or more electronic message data items, in the database, until receipt of a request from the specific user; retrieves, upon receipt of the request from the specific user, the one or more electronic message data items from the database; and transmits, based on the contact information, the one or more electronic message data items to the second electronic device. Furthermore, the system, wherein the identity of the specific user is unbeknownst to the first electronic device prior to generating the request. Moreover, the system, wherein the criteria for identifying the particular type of user and the one or more user profiles further comprise physical location data that matches. Further, the system, wherein the criteria for identifying the particular type of user further comprise one or more role parameters and the one or more user profiles further comprise one or more roles that match the one or more role parameters. Additionally, the system, wherein the criteria for identifying the particular type of user further comprise an affinity for a subject matter and the one or more roles further comprise the subject matter. Also, the system, wherein the one or more roles are defined based on movement of electronic devices.

According to one aspect of the present disclosure, the system, wherein each of the one or more roles corresponds to a particular pattern of movement of electronic devices. Furthermore, the system, wherein the particular pattern of movement of electronic devices corresponds to a defined time period. Moreover, the system, wherein determining, based on the connection information, a specific user to contact is further based on a priority of the identified one or more users defined by one or more predefined rules. Further, the system, wherein the connection is of a predefined type defined by the request, the contact information, or the one or more user profiles.

According to one aspect of the present disclosure, the method, further comprising the steps of: receiving communication data regarding one or more electronic devices associated with the one or more determined roles, wherein the communication data regarding the one or more electronic devices comprises communication data regarding the particular electronic device; comparing the communication data regarding the particular electronic device with the communication data regarding the one or more electronic devices; and determining, based on the comparison, a relative amount of communication of the particular electronic device. Additionally, the method, wherein the particular electronic device comprises a first electronic device, further comprising the steps of: receiving a request from a second electronic device to contact a user associated with the one or more determined roles, wherein the request comprises one or more electronic data items that identify the one or more determined roles; comparing the one or more electronic data items to one or more predefined communication rules, wherein the one or more predefined communication rules define a priority of the one or more determined roles and one or more users corresponding to each of the one or more determined roles, wherein the one or more users comprise a user of the first electronic device; determining, based on the comparison, to contact the user of the first electronic device; retrieving connection information regarding the user of the first electronic device, wherein the connection information comprises contact information for the first electronic computing device; establishing a connection, based on the contact information, between the second electronic device and the first electronic device.

According to one aspect of the present disclosure, the system, wherein the server: receives communication data regarding one or more electronic devices associated with the one or more determined roles, wherein the communication data regarding the one or more electronic devices comprises communication data regarding the electronic device; compares the communication data regarding the electronic device with the communication data regarding the one or more electronic devices; and determines, based on the comparison, a relative amount of communication of the electronic device. Also, the system, wherein the electronic device comprises a first electronic device, further comprising: a second electronic device that generates a request to contact a user associated with the one or more determined roles, wherein the request comprises one or more electronic data items that identify the one or more determined roles, and transmits the request to the server; the server that receives the request from the second electronic device, wherein the server: compares the one or more electronic data items to one or more predefined communication rules, wherein the one or more predefined communication rules define a priority of the one or more determined roles and one or more users corresponding to each of the one or more determined roles, wherein the one or more users comprise a user of the first electronic device; determines, based on the comparison, to contact the user of the first electronic device; retrieves connection information regarding the user of the first electronic device, wherein the connection information comprises contact information for the first electronic computing device; and establishes a connection, based on the contact information, between the second electronic device and the first electronic device; and the second electronic device that connects with the first electronic device.

These and other aspects, features, and benefits of the claimed invention(s) will become apparent from the following detailed written description of the preferred embodiments and aspects taken in conjunction with the following drawings, although variations and modifications thereto may be effected without departing from the spirit and scope of the novel concepts of the disclosure.

### BRIEF DESCRIPTION OF THE DRAWINGS

The accompanying drawings illustrate one or more embodiments and/or aspects of the disclosure and, together with the written description, serve to explain the principles of the disclosure. Wherever possible, the same reference numbers are used throughout the drawings to refer to the same or like elements of an embodiment, and wherein:

FIG. 1 illustrates an exemplary, high-level overview of one embodiment of the disclosed system.

FIG. 2 illustrates an exemplary architecture of one embodiment of the disclosed system.

FIG. 3 is a flowchart showing an exemplary application process, according to one embodiment of the present disclosure.

FIG. 4 is a flowchart showing an exemplary registration process, according to one embodiment of the present disclosure.

FIG. 5 is a flowchart showing an exemplary user community determination process, according to one embodiment of the present disclosure.

FIG. 6 is a flowchart showing an exemplary user contact process, according to one embodiment of the present disclosure.

FIG. 7 is a flowchart showing an exemplary message generation process, according to one embodiment of the present disclosure.

FIG. 8 is a flowchart showing an exemplary page generation and presentation process, according to one embodiment of the present disclosure.

### DETAILED DESCRIPTION

For the purpose of promoting an understanding of the principles of the present disclosure, reference will now be made to the embodiments illustrated in the drawings and specific language will be used to describe the same. It will, nevertheless, be understood that no limitation of the scope of the disclosure is thereby intended; any alterations and further modifications of the described or illustrated embodiments, and any further applications of the principles of the disclosure as illustrated therein are contemplated as would normally occur to one skilled in the art to which the disclosure relates. All limitations of scope should be determined in accordance with and as expressed in the claims.

Whether a term is capitalized is not considered definitive or limiting of the meaning of a term. As used in this document, a capitalized term shall have the same meaning as an uncapitalized term, unless the context of the usage specifically indicates that a more restrictive meaning for the capitalized term is intended. However, the capitalization or lack thereof within the remainder of this document is not intended to be necessarily limiting unless the context clearly indicates that such limitation is intended.

### Overview

Aspects of the present disclosure generally relate to systems and methods for enabling communications between individuals based on the roles of the individuals and establishing that role based (at least in part) on the behavior of the individuals.

Generally, smartphone users download an application with functionality corresponding to the present disclosure. That application permits users to form communities based on a central topic for which they may have a common affinity or association (e.g., a particular breed of dogs, conference at which the users are attending, restaurant at which the users are dining, private club, sporting event/team, physical or geographic location, neighborhood, etc.). When connected to these communities, the smartphones gather information regarding the users to determine the users' roles within the community so that a user does not need to define their role within the community and so that other users can accurately contact other users within the community that have a certain role. Generally, by automatically defining a user's role, the communities may not need an administrator to manage users within the community (e.g., as new users are added, as users change roles, etc.). For example, in a restaurant-based community that contains users who are patrons of the restaurant, staff of the restaurant, owners of the restaurant, etc., Bluetooth® beacons may be placed at each table so that location data may be gathered regarding the users to establish a user's role within the restaurant-based community (e.g., patron, manager, waiter, etc.). Continuing with this example, a waiter may be identified because the smartphone constantly moves from table to table (e.g., constantly passing multiple Bluetooth® beacons). Similarly, a user who is constantly interacting with the waiters (e.g., meeting with them in a particular room, answering their questions within the community, etc.) may be identified as a manager of the restaurant. Further, a user who was previously identified as a patron may be re-identified as a waiter if the user begins to constantly move from table to table.

In various embodiments, the automatically generated/identified/defined roles of the users within the community permit the application to enable various functionality, such as anonymous communications between users based on the role of the users (e.g., no contact information or names need to be provided to the users). Generally, this permits a user to receive information from another user based on the type of information the user wants to receive without requiring multiple attempts to find the appropriate user to provide that information. For example, a patron may need to speak with a manager regarding a complaint about a waiter; thus, the patron may indicate, within the application, that the user wants to speak with a manager and will be connected to a manager without first needing to know the identity of that manager or asking the waiter to speak with the manager. Similarly, at a conference, a user may contact a particular type of vendor (e.g., office machines, etc.) without needing to know which specific vendors are at the conference or the types of equipment those vendors provide. Based on the identified roles, the system may generate multiple different metrics such as a heat map that shows the types of communications occurring on the system based on the roles of the users making those communications, the amount of time a user is active within a particular location, etc.

In one embodiment, the application initiates at the request of a user or when the user enters a particular location. Based on the user's profile information and access permissions granted by the user within the smartphone, the application determines the appropriate community in which to place the user. The application then generates a page with relevant information regarding the community, based on that user's role within the same, to present to the user. Within the community, the user may communicate with other users, navigate between pages, request information, etc. Generally, the application facilitates any action that the user wishes to take.

### Exemplary Embodiments

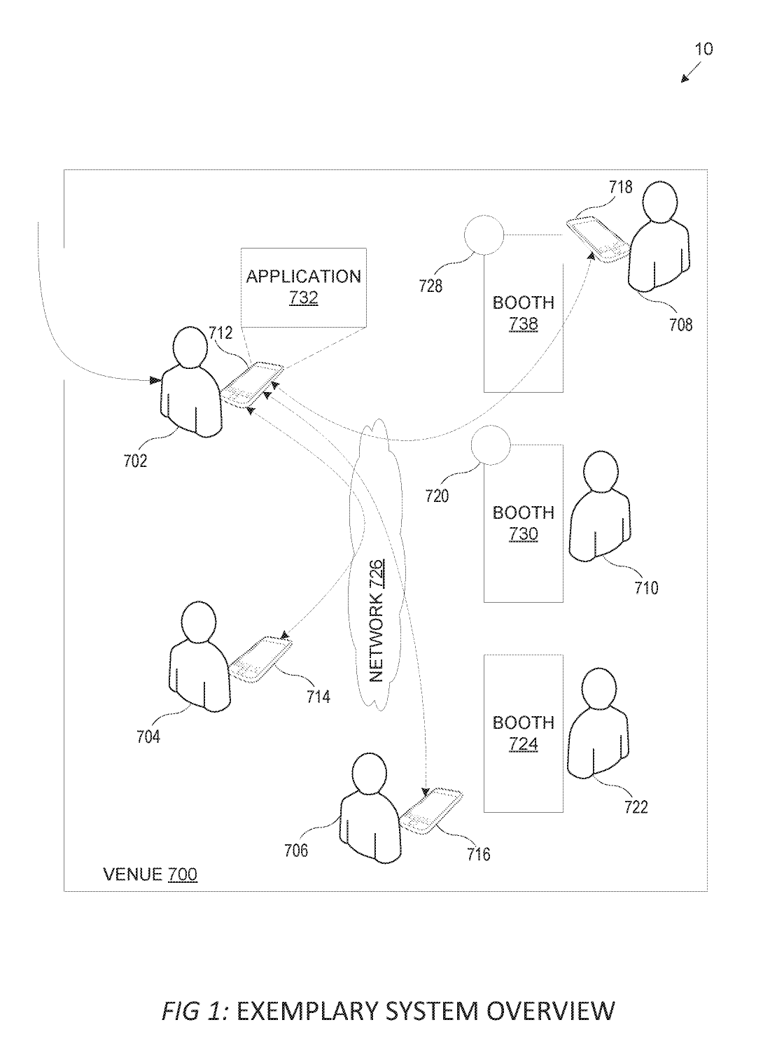

Referring now to the figures, for the purposes of example and explanation of the fundamental processes and components of the disclosed systems and methods, reference is made to FIG. 1, which illustrates an exemplary, high-level overview 10 of one embodiment of the disclosed system. As will be understood and appreciated, the exemplary, high-level overview shown in FIG. 1 represents merely one approach or embodiment of the present system, and other aspects are used according to various embodiments of the present system. Generally, the disclosed system provides information to and anonymous connections between individual users of the system within a community that may be related to a particular topic (e.g., a sports team, dog breed, etc.), venue 700 (e.g., conference, hotel, stadium, restaurant, retail store, etc.), or other concept. Accordingly, the users of the system are able to interact with each other and retrieve relevant information while in the community.

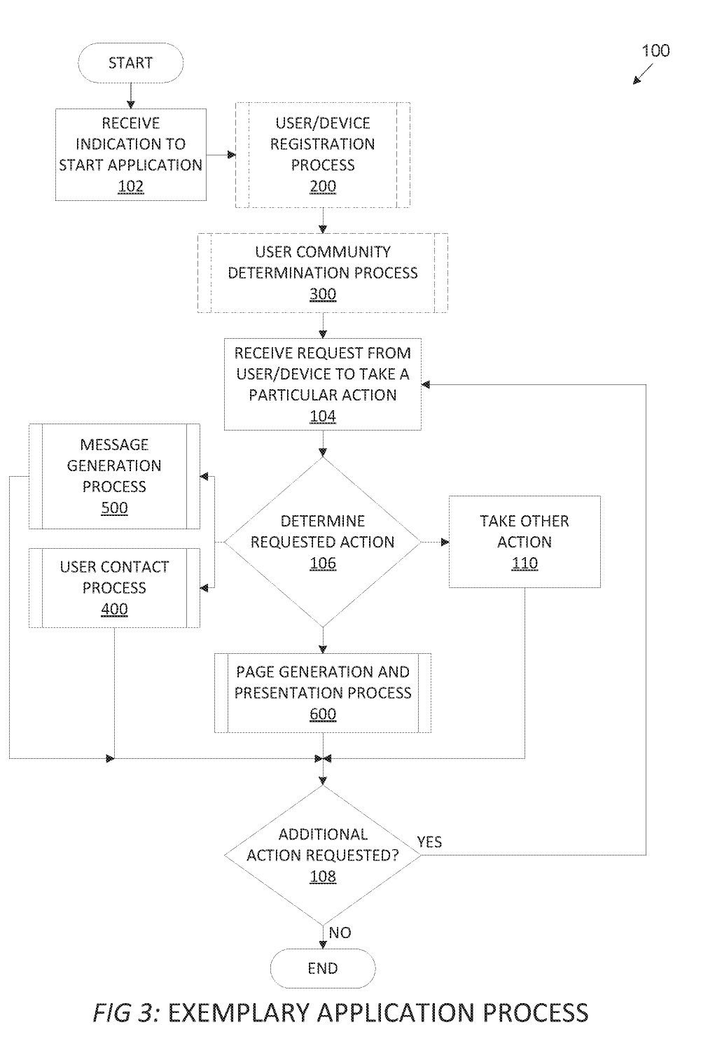

In various embodiments, when a user 702 enters the venue 700, the mobile computing device 712 of that user 702 initiates the application 732 (further details of which are discussed in association with FIGS. 3-8) so that the user 702 may connect with other users 704, 706, and 708 within the venue 700. Generally, in one embodiment, the application 732 may initiate because the user 702 enters the venue 700, and the system recognizes that the application 732 should initiate based on the physical location of the mobile computing device 712 (e.g., the mobile computing device 712 enters a geofenced location, etc.). In one alternate embodiment, the user 702 may manually initiate the application 732 (e.g., by opening the application 732 on the mobile computing device 712, etc.). In various embodiments, once the application has been initiated, users that have already registered with the system are placed into a particular community (e.g., a collection of users with relationships based on predefined criteria) associated with that venue 700. Within that community, the user 702 may take several actions such as communicating with another user, retrieving information about the community or its members, requesting assistance, navigating to new pages, etc.

Generally, the application 732 allows the user 702 to communicate, using the mobile computing device 712 on which the application 732 is running and a communications network 726, with other users 704, 706, and 708 within a particular community through their respective mobile computing devices 714, 716, and 718 that would be running versions of the application 732. These users may be patrons of the venue (e.g., users 704 and 706), staff/management of the venue (e.g., user 708), etc. As will be understood by one having ordinary skill in the art, the network 726 may comprise any connection capable of transferring data between two or more computer systems (e.g., Bluetooth, wireless or wired local-area networks (LANs), cell network, etc.).

Referring still to FIG. 1, in various embodiments, the application 732 permits the user 702 to contact a specific user (e.g., user 704) or a specific type of user (e.g., managers, users who can answer a particular type of question, users operating booths such as user 708, etc.). For example, when the user 702 enters the venue 700 and has a question regarding a particular booth (e.g., booth 738) within the venue 700, the user 702 may initiate a communication regarding the booth and it will be forwarded to the user associated with that booth (e.g., user 708). Similarly, if the user 702 wishes to contact a particular user (e.g., user 704), then the user may initiate that communication via the application 732 as well.

The application 732, in various embodiments, determines a user's role within that community based on the particular user's actions. This determination may occur based on a combination of location, activity, and role-based rules and criteria/parameters that are applied to the particular user's actions (e.g., duration of time within a location, number of locations visited in a predefined period of time, order of locations visited, etc.). For example, if a user (e.g., user 708), stands next to a booth (e.g., booth 738) with a particular location beacon (e.g., 728) for a long period of time, then the system may identify that user as the owner of the booth. Similarly, if a user (e.g., user 702) walks past several booths (e.g., 738 and 730) with location beacons (e.g., 728 and 720, respectively) in a short period of time, then the system may identify that user as a patron of the conference 700. Generally, a location beacon may be any device/sensor capable of interacting with the system and the mobile computing devices to provide location information regarding the mobile computing devices (e.g., Bluetooth® beacon, WIFI positioning systems, Global Position Systems, near field communications, Quick Result Codes, Indoor Position Systems, etc.). In one embodiment, the system may use multiple location beacons to determine the location of a particular mobile computing device (e.g., Bluetooth® beacon and a scan of a UPC code using the smartphone's camera, etc.). In one embodiment, the system many not comprise any location beacons.

In various embodiments, the system may have information about individuals (e.g., nonuser 722) and locations (e.g., 724) that are not registered with the system based on their interactions with registered users. For example, if user 702 visits booth 724, meets nonuser 722, and subsequently adds information regarding nonuser 722 to the community, then the system may become aware of nonuser 722 and his/her relationship to booth 724. Subsequently, other users (e.g., users 704 and/or 706), could find nonuser 722 at booth 724 based on a suggestion by the system that booth 724 is a likely location to do the same.

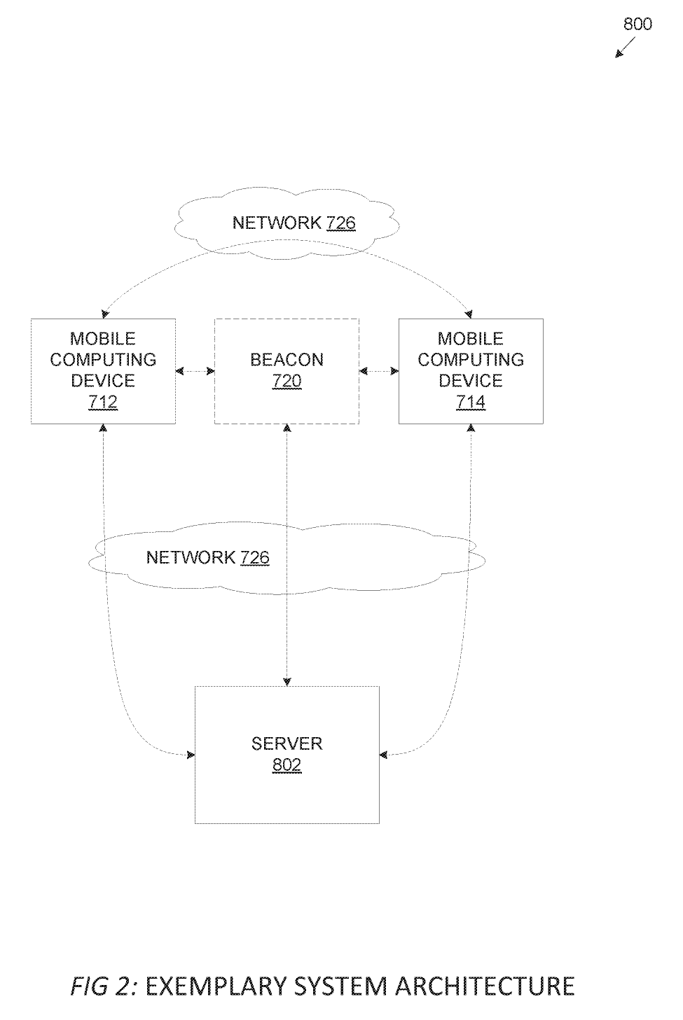

Now referring to FIG. 2, an exemplary system architecture 800 is shown according to one embodiment of the present disclosure. In various embodiments, the system comprises one or more mobile computing devices 712 and 714, one or more optional location beacons 720, and a server 802 operatively connected via network 726. Generally, the mobile computing devices 712 and 714 are any devices that are capable of performing the functionality disclosed herein (e.g., laptop computer, tablet computer, smartphone, smartwatch, etc.). In various embodiments, the mobile computing devices 712 and 714 communicate via network 726 with the server 802 and optional location beacons 720 to perform the application process. Further details of the application process will be discussed in association with the description of FIG. 3. Generally, network 726 may be a secure or unsecured connection, local area network, the interne, cellular network, etc.

The server 802, in one embodiment, may be any computing device (e.g., desktop computer, laptop, servers, tablets, etc.), combination of computing devices, software, hardware, combination of software and hardware, database (e.g., stored in the cloud or on premise, structured as relational, etc.), or combination of databases that is capable of performing the functionality disclosed herein. Similarly, the optional location beacons 720 may be any device/sensor capable of interacting with the system and the mobile computing devices to provide location information regarding the mobile computing devices (e.g., Bluetooth® beacon, WIFI positioning systems, Global Position Systems, near field communications, Quick Result Codes, Indoor Position Systems, etc.), which may be used to define a user's role within a particular community.

Referring now to FIG. 3, a flowchart summarizing an exemplary application process 100, according to one embodiment of the present disclosure, is shown. As will be understood by one having ordinary skill in the art, the steps and processes shown in FIG. 3 (and those of all other flowcharts and sequence diagrams shown and described herein) may operate concurrently and continuously, are generally asynchronous and independent, and are not necessarily performed in the order shown. In various embodiments, the exemplary application process 100 is the process by which an application according to the present disclosure operates on a mobile computing device.

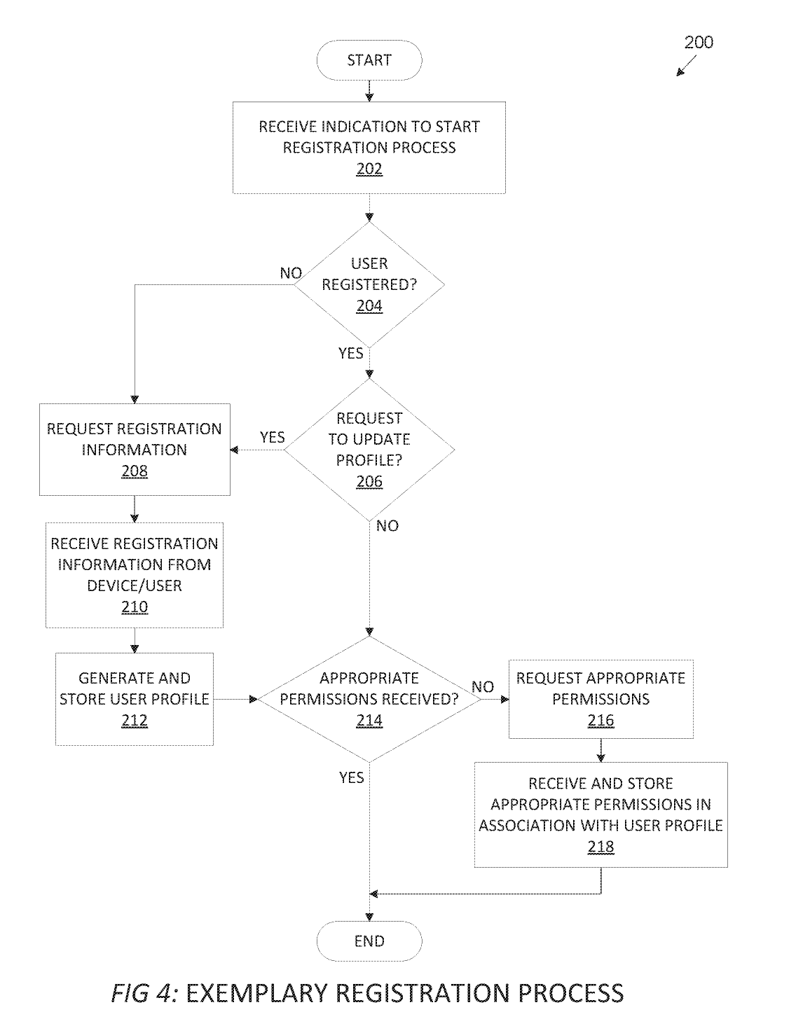

In various embodiments, the exemplary application process 100 begins at step 102 when the system receives an indication to start. Generally, one or more predefined rules will define activation at step 102. For example, the user may actively initiate the application (e.g., by selecting an icon representing the application on the mobile computing device's user interface, etc.) or by performing an action that initiates the application (e.g., entering a particular physical location, moving the mobile device in a particular manner, etc.). Thus, after step 102 in one embodiment, the system begins the user/device registration process 200 wherein the system registers the user, updates the user's profile, and/or requests the appropriate configuration permissions from the mobile computing device (further details of the user/device registration process 200 will be explained in association with the description of FIG. 4). In one embodiment, the system will skip the user/device registration process 200 (and the user community determination process 300) because the user is already registered with the system.

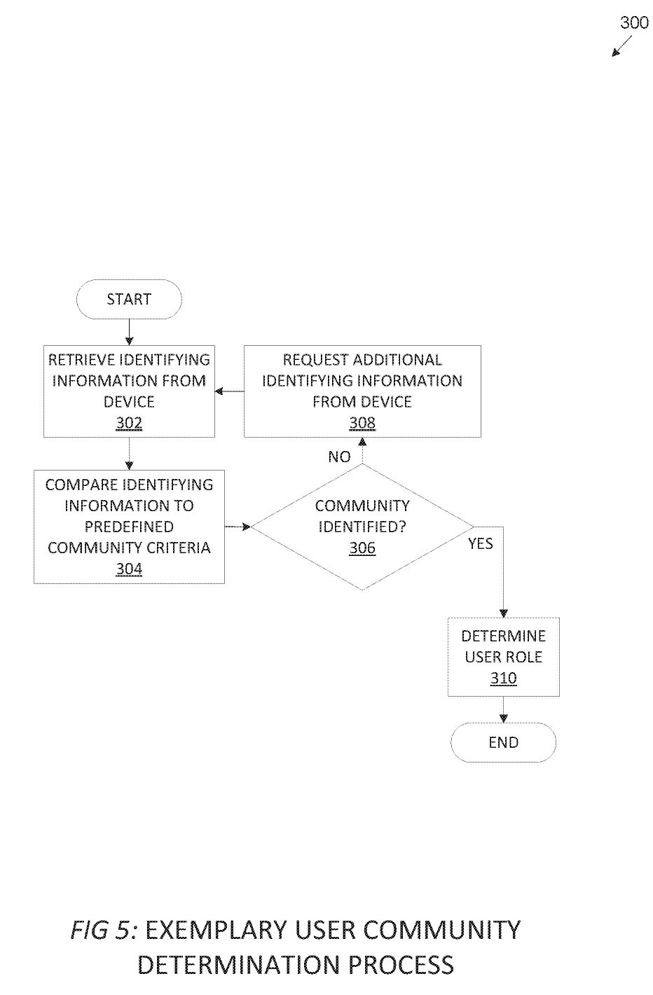

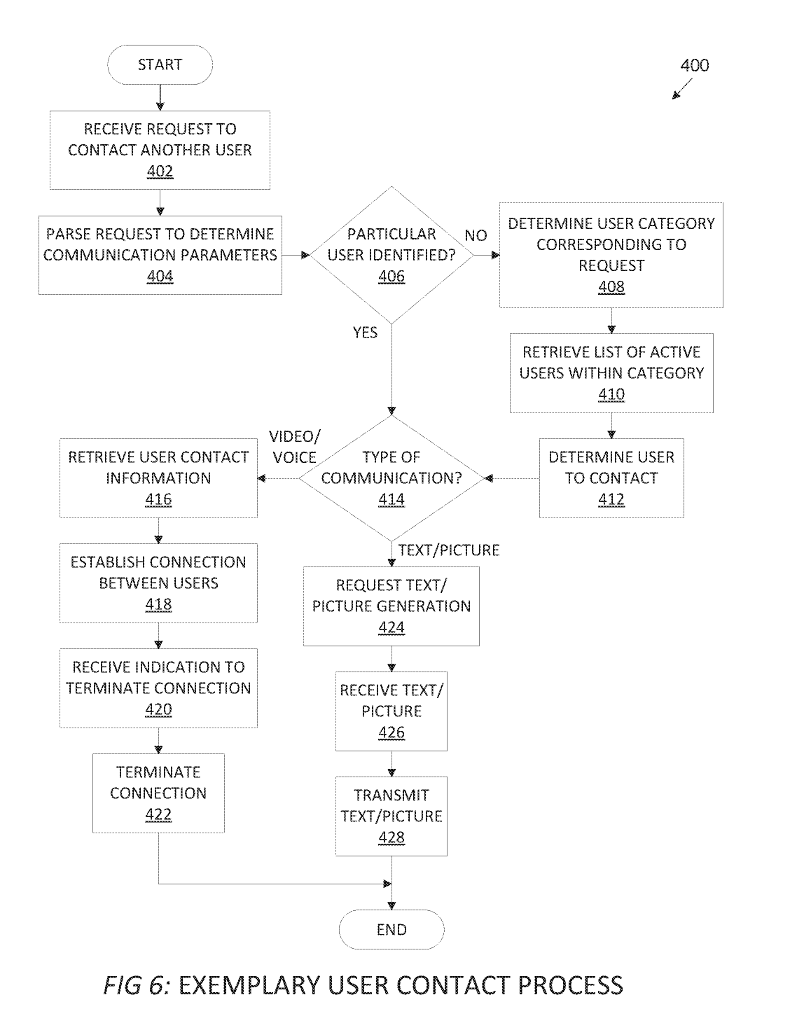

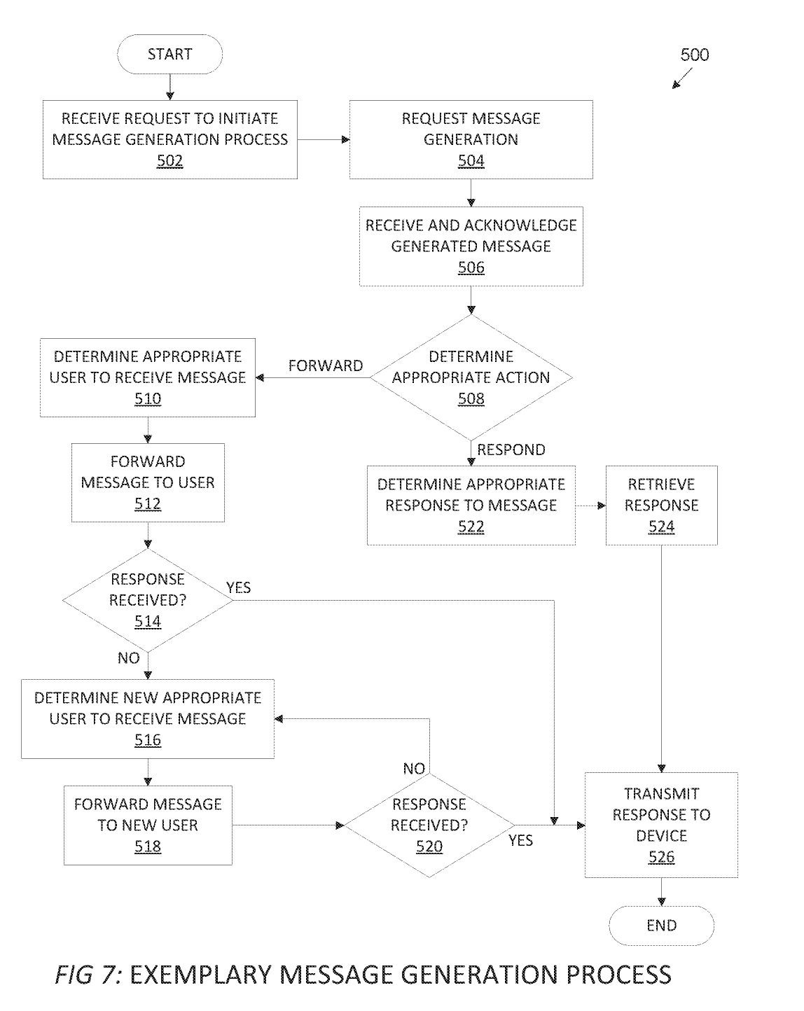

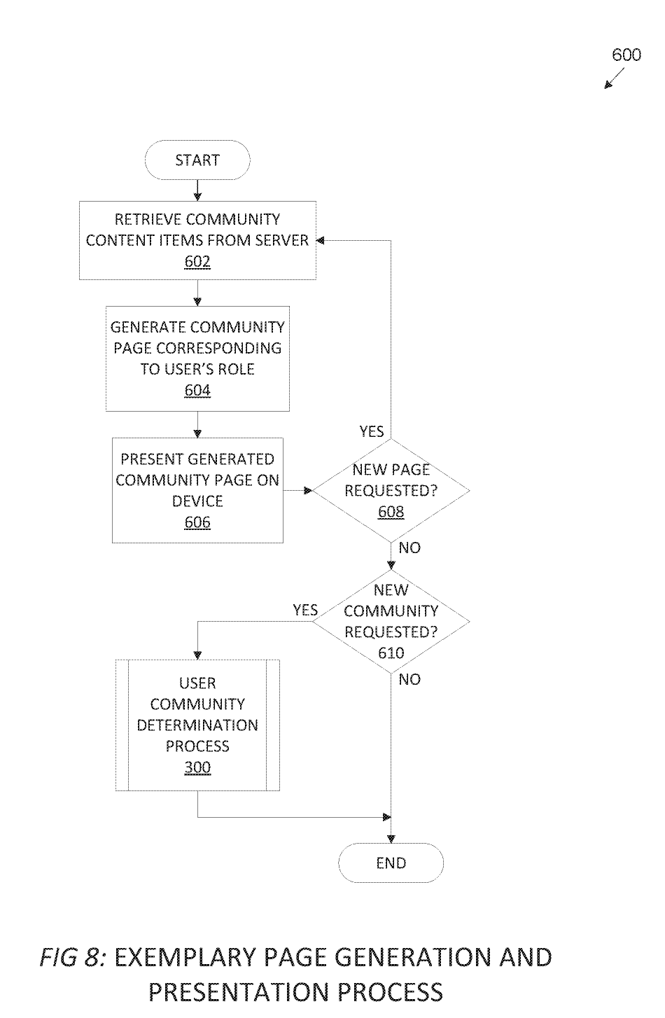

After the user/device registration process 200, in one embodiment, the system begins the user community determination process 300 wherein the system determines the particular community that the user should initially access and the user's role within that community (further details for the user community determination process 300 will be explained in association with the description of FIG. 5). At step 104, in various embodiments, the system receives a request from the user and/or mobile computing device to take a particular action (e.g., contact another user within the community, generate a message, navigate to a new page within the community, retrieve information, switch to a new community, etc.). Thus, in one embodiment, at step 106, the system determines the particular requested action. If, at step 106, the system determines that the user wishes to contact another user within the community, then, in various embodiments, the exemplary application process 100 proceeds to the user contact process 400 (further details of which will be explained in association with the description of FIG. 6) wherein the system contacts another user within the community. If, at step 106, the system determines that the user wishes to generate a message, then, in various embodiments, the exemplary application process 100 proceeds to the message generation process 500 (further details of which will be explained in association with the description of FIG. 7) wherein the system generates a message. If, at step 106, the system determines that the user wishes to navigate to another page or community, then, in various embodiments, the exemplary application process 100 proceeds to the page generation and presentation process 600 (further details of which will be explained in association with the description of FIG. 8) wherein the system generates and presents a new page within the community to the user. If, at step 106, the system determines that the user wishes to another action, then, in various embodiments, the exemplary application process 100 proceeds at step 110 wherein the system takes the requested other action (e.g., unregistering a user from a community, automatically creating a new community/sub-community, etc.).

After completion of the user contact process 400, the message generation process 500, the page generation and presentation process 600, or the other action at step 110, in various embodiments, the exemplary application process 100 determines, at step 108, whether the user wishes to perform another action. If the user wishes to perform another action, then, in one embodiment, the exemplary application process 100 returns to step 104. If, however, the user does not wish to perform another action, then, in one embodiment, the exemplary application process 100 ends thereafter (e.g., the application closes, enters a standby mode, simply awaits further requests, etc.).

Now referring to FIG. 4, a flowchart summarizing an exemplary registration process 200, according to one embodiment of the present disclosure, is shown. Generally, the exemplary registration process 200 is the process by which a user registers with the system, the system generates/updates the user's profile, and/or the system receives the appropriate configuration permissions from the mobile computing device.

Accordingly, the exemplary registration process 200 begins at step 202, wherein the system receives an indication to start the registration process (e.g., after step 102 from FIG. 3). Generally, the system determines, at step 204, whether the user is already registered with the system (e.g., the user has previously used the application and already has an existing profile within the system). If the user is not registered with the system, then, at step 208 in one embodiment, the system requests registration information from the user (e.g., identifying information regarding the user such as name, contact information, job title, interests, etc.), which the user is able to input using the mobile computing device, or pulls that information automatically from a social media account or other third party system associated with the user. In various embodiments, at step 210, the system receives the registration information from the mobile computing device/user. Thus, in one embodiment, at step 212, the system generates and stores a user profile based on the registration information. For example, the system may use predefined rules to establish a user profile based on certain information (e.g., users from a particular location, etc.). In one embodiment, the user may request and generate an alias for his/herself to make his/her interactions within the community anonymous. Generally, this alias would be stored as a new user profile with identifying information regarding the mobile computing device. After storing and generating the profile, the system proceeds, at step 214 in various embodiments, to determine whether the appropriate access permissions have been received from the user.

If the system determines, at step 204, that the user was already registered, then the system proceeds at step 206 to determine whether any updates are needed for the profile (e.g., the information is too old, the information appears inconsistent based on the current status of the mobile computing device, etc.). Generally, if updates are needed, then the process proceeds at step 208 (previously discussed herein). If, however, updates are not needed, then the system proceeds to step 214.

If, in one embodiment, at step 214, the system determines that appropriate permissions have not been received, then the system requests those permissions at step 216. In various embodiments, these permissions allow the application to access functionality of the mobile computing device (e.g., GPS information, contacts information, cellular data, calendar information, etc.). Generally, the system receives and stores the permissions in association with the user profile at step 218, and the exemplary registration process 200 ends thereafter. If, however, the system determines that appropriate permissions have already been received, then the exemplary registration process 200 ends thereafter.

Now referring to FIG. 5, a flowchart summarizing an exemplary user community determination process 300, according to one embodiment of the present disclosure, is shown. Generally, the exemplary user community determination process 300 is the process by which the system determines into which community within the system a user should be placed, either soon after starting the application (e.g., after the exemplary registration process 200) or at the request of the user (e.g., as part of the exemplary page generation and presentation process 600). Generally, the exemplary user community determination process 300 may occur automatically or at the request of the user. For example, the system automatically determines that a user entering a restaurant should be placed into the community for that restaurant. If the user is watching a sporting event at the restaurant, then the user could request to be placed into the community for that sporting event instead. Similarly, a user may request to toggle between communities (e.g., between the restaurant and sporting event communities).

In various embodiments, the exemplary user community determination process 300 begins at step 302 wherein the system retrieves identifying information from the device (e.g., user profile, device identification number, etc.). Generally, at step 304, the system compares the identifying information to predefined criteria for each community within the system to determine into which community the user should be placed. For example, if the user is registered with three different communities, but the physical location of the mobile device is currently within an area associated with only one of those communities, then the system will place the user into that community. Thus, at step 306, the system determines whether a community has been identified. If a community has not been identified, then, at step 308, the system requests additional identifying information from the device (e.g., a name/identifier of a particular community, etc.) and the exemplary user community determination process 300 returns to step 302. If, however, a community has been identified, then the system determines, at step 310, the user's role within that community. Generally, a user's profile may contain the user's role. In one embodiment, a user's role may be determined based on that user's behavior in comparison with certain predefined rules (e.g., location of user, activities of user with respect to that location or other users, role-based, etc.). These predefined rules may be establishing upon creation of the community by an administration or other members of the community or automatically according to the type of community (e.g., restaurant-based communities receive certain rules, etc.). For example, a user may be identified as a waiter if the user constantly moves between tables in a restaurant. Similarly, a user may be identified as a security guard if the user does not move from in front of a high value painting in a museum. Generally, the system will gather historical data regarding the user's actions (e.g., time-stamped location data; gathered using the user's smartphone in association with one or more location-based functionalities of the smartphone such as GPS, Bluetooth®, camera, etc.; etc.), store it in association with the user's profile, and compare that data against predefined rules for a particular community to determine the user's role within that community. Thus, if a user's actions were to change, the user's role would change as well. After determining the user's role, then the exemplary user community determination process 300 ends thereafter.

Now referring to FIG. 6, a flowchart summarizing an exemplary user contact process 400, according to one embodiment of the present disclosure, is shown. Generally, the exemplary user contact process 400 is the process by which a user contacts another user within a community using the system. For example, if a visitor at an office equipment conference wishes to contact a telephone salesman, then the visitor could contact the telephone salesman through the system. Generally, the system uses a message broker (e.g., Apache Apollo, etc.) to conduct the exemplary user contact process 400. In one embodiment, the user may be attempting to contact another user without knowledge of that user's contact information (e.g., based on that user's role within the community).

In various embodiments, the exemplary user contact process 400 begins at step 402 when the system receives a request to contact another user. Generally, the request may correspond to a request to contact a particular user (e.g., when the user has the contact information of the particular user) or particular type of user (e.g., when the user wishes to contact a user based on that user's role and does not have that user's contact information) and may comprise various types of identifying information for the user such as the user's profile, contact information, role type, etc. Thus, at step 404, in one embodiment, the system parses the request to determine the particular communication parameters of the requests (e.g., whether the user wishes to make a voice, video, text, picture, etc. communication, whether the user wishes to contact a particular users, whether the user wishes to contact a particular type of user, etc.) and determines, at step 406, if a particular user has been identified within the request.

If a particular user has not been identified within the request (e.g., because the user is not aware of the manager's name/contact information within a restaurant but wishes to speak with the manager), then, in one embodiment at step 408, the system determines the particular user category corresponding to the request (e.g., waiters, managers, hammer salesmen, etc.). After determining the particular user category, at step 410 in one embodiment, the system retrieves a list of currently active users within the community that correspond to that user category (e.g., based on their user profiles, etc.). At step 412, the system, in one embodiment, determines the user within that list to contact. Generally, the system may contact users according to preferences of the user making the communication, predefined rules for the community, or may display the list of currently active users to the user making the request for selection by the user. Similarly, the system may generate a relative ranking of the users with a certain category based on the number of communications that each user is receiving, and a user may select another user to contact based on that relative ranking.

After step 412 or if a particular user was identified at step 406, in various embodiments, the system determines the particular type of communication to which the request corresponds at step 414 (e.g., video, voice, text, picture, etc.). If the request corresponds to a video or voice call, then in various embodiments, at step 416, the system retrieves the contact information corresponding to the identified user (but does not necessarily provide that contact information to the user making the communication, unless specified in the predefined rules of the community or by the identified user) and establishes a connection between the users at step 418 so that the users may communicate with one another. After the communication is complete, the system in one embodiment receives an indication to terminate the connection at step 420 (e.g., because one user hangs up, etc.). Thus, in one embodiment at step 422, the system terminates the connection between the users and the exemplary user contact process 400 ends thereafter.

If the request corresponds to a text or picture message, then at step 424 in various embodiments, the system requests generation by the user of the text and/or picture to be transmitted to the identified user, which may be generated using any of the functionality of the mobile computing device (e.g., camera of the smartphone to take a picture of an item of interest or barcode, keyboard of the smartphone, etc.). Thus, at step 426 in various embodiments, the system receives the text/picture to be transmitted and transmits the text/picture, at step 428, to the identified user based on that user's contact information. After transmitting the text/picture to the identified user, the exemplary user contact process 400 ends thereafter. Generally, the system stores messages for users who are not currently connected to the system, so messages get delivered the next time the user enters the community.

Now referring to FIG. 7, a flowchart summarizing an exemplary message generation process 500, according to one embodiment of the present disclosure, is shown. Generally, the exemplary message generation process 500 is the process by which the system receives and responds, automatically, to a message from a user. For example, if a patron has a problem with one of the items they have been served at a restaurant, they could generate a message relating to the problem and send it to the system. In this example, the system would receive the message, determine the appropriate response to the message, and pursue that response until the message has been handled appropriately (e.g., escalating requests from waiter to waiter, to managers, etc.).

In various embodiments, the exemplary message generation process 500 begins at step 502, when the system receives a request, from the user, to initiate the same. Thus, at step 504 in one embodiment, the system requests that the user generate a message (e.g., through the functionality of the mobile computing device). At step 506, in one embodiment, the system receives the generated message from and acknowledges receipt to the user. In various embodiments, at step 508, the system automatically determines the appropriate action to take with regards to the message based on predefined rules. For example, the system may parse the message for certain keywords (e.g., a role type such as waiter, a name of a particular user, etc.) and, based on the information within the system, route the message accordingly. If the system is able to respond to the message automatically (e.g., the system already has a canned response to the message either because another user has generated the canned response or the system has respond to a similar message previously), then at step 522 in various embodiments, the system determines the appropriate response to the message and retrieves that response from the server at step 524. For example, if a user asks what time is last call at a bar and the system is aware of that information, then the system could provide that information directly to the user. If the system requires another user's input to respond to that message, then at step 510, in one embodiment, the system determines the appropriate user to receive the message and, at step 512, forwards the message to that user for response. At step 514, the system determines, in one embodiment, whether a response has been received to the message. If a response has not been received, then the system, at step 516 in various embodiments, determines a different user to forward the received message to and, at step 518, forwards the message to that different user. Thus, at step 520, in various embodiments, the system determines again if it has received a response to that message. If it has not received a response, then it returns to step 516 and continues to forward the message to new users to receive a response. For example, if a viewer at a sporting event needs a medic, then the system could contact a medic and provide the user's location to the medic. Continuing with this example, if the medic does not move to that location, then the system could contact another medic with the same request. Once it determines that it has received a response (either at step 514 or 520) or it has retrieved the response (at step 524), then the system transmits the response to the mobile computing device at step 526, in various embodiments, and the exemplary message generation process 500 ends thereafter.

Now referring to FIG. 8, a flowchart summarizing an exemplary page generation and presentation process 600, according to one embodiment of the present disclosure, is shown. Generally, the exemplary page generation and presentation process 600 is the process by which the system generates and presents pages within the communities to the users on the mobile computing device (when the application starts and as the user navigates through the pages of the community).

In various embodiments, the exemplary page generation and presentation process 600 begins at step 602 wherein the system retrieves community content items from the server (e.g., items that are automatically generated according to a template, etc.). Thus, at step 604 in one embodiment, the system generates a community page corresponding to the user's role within that community based on the retrieved community content items (e.g., IP address for the community, temporary phone extensions, IP address for target page, calendars, bulletins, images, notices, objects, etc.) and, in one embodiment, one or more predefined templates. Generally, at step 606, the system presents the generated community page on the mobile computing device for use by the user (e.g., using XSLT, HTML, or other programming languages). In various embodiments, at step 608 the system determines whether the user has requested a new page (e.g., by clicking on a link within the current page, moving to a new location within a venue, etc.). If the user has requested a new page, then in one embodiment, the exemplary page generation and presentation process 600 returns to step 602. If, however, the user has not requested a new page, then, in one embodiment, the system determines at step 610 whether the user has requested a new community. If the user has requested a new community, then in one embodiment, the exemplary page generation and presentation process 600 proceeds to the user community determination process 300 (further details of which were discussed in association with the description of FIG. 5) and the exemplary page generation and presentation process 600 ends thereafter. If, however, the user has not requested a new community, then the exemplary page generation and presentation process 600 ends thereafter.

From the foregoing, it will be understood that various aspects of the processes described herein are software processes that execute on computer systems that form parts of the system. Accordingly, it will be understood that various embodiments of the system described herein are generally implemented as specially-configured computers including various computer hardware components and, in many cases, significant additional features as compared to conventional or known computers, processes, or the like, as discussed in greater detail herein. Embodiments within the scope of the present disclosure also include computer-readable media for carrying or having computer-executable instructions or data structures stored thereon. Such computer-readable media can be any available media which can be accessed by a computer, or downloadable through communication networks. By way of example, and not limitation, such computer-readable media can comprise various forms of data storage devices or media such as RAM, ROM, flash memory, EEPROM, CD-ROM, DVD, or other optical disk storage, magnetic disk storage, solid state drives (SSDs) or other data storage devices, any type of removable non-volatile memories such as secure digital (SD), flash memory, memory stick, etc., or any other medium which can be used to carry or store computer program code in the form of computer-executable instructions or data structures and which can be accessed by a general purpose computer, special purpose computer, specially-configured computer, mobile device, etc.

When information is transferred or provided over a network or another communications connection (either hardwired, wireless, or a combination of hardwired or wireless) to a computer, the computer properly views the connection as a computer-readable medium. Thus, any such a connection is properly termed and considered a computer-readable medium. Combinations of the above should also be included within the scope of computer-readable media. Computer-executable instructions comprise, for example, instructions and data which cause a general purpose computer, special purpose computer, or special purpose processing device such as a mobile device processor to perform one specific function or a group of functions.

Those skilled in the art will understand the features and aspects of a suitable computing environment in which aspects of the disclosure may be implemented. Although not required, some of the embodiments of the claimed inventions may be described in the context of computer-executable instructions, such as program modules or engines, as described earlier, being executed by computers in networked environments. Such program modules are often reflected and illustrated by flow charts, sequence diagrams, exemplary screen displays, and other techniques used by those skilled in the art to communicate how to make and use such computer program modules. Generally, program modules include routines, programs, functions, objects, components, data structures, application programming interface (API) calls to other computers whether local or remote, etc. that perform particular tasks or implement particular defined data types, within the computer. Computer-executable instructions, associated data structures and/or schemas, and program modules represent examples of the program code for executing steps of the methods disclosed herein. The particular sequence of such executable instructions or associated data structures represent examples of corresponding acts for implementing the functions described in such steps.

Those skilled in the art will also appreciate that the claimed and/or described systems and methods may be practiced in network computing environments with many types of computer system configurations, including personal computers, smartphones, tablets, hand-held devices, multi-processor systems, microprocessor-based or programmable consumer electronics, networked PCs, minicomputers, mainframe computers, and the like. Embodiments of the claimed invention are practiced in distributed computing environments where tasks are performed by local and remote processing devices that are linked (either by hardwired links, wireless links, or by a combination of hardwired or wireless links) through a communications network. In a distributed computing environment, program modules may be located in both local and remote memory storage devices.

An exemplary system for implementing various aspects of the described operations, which is not illustrated, includes a computing device including a processing unit, a system memory, and a system bus that couples various system components including the system memory to the processing unit. The computer will typically include one or more data storage devices for reading data from and writing data to. The data storage devices provide nonvolatile storage of computer-executable instructions, data structures, program modules, and other data for the computer.

Computer program code that implements the functionality described herein typically comprises one or more program modules that may be stored on a data storage device. This program code, as is known to those skilled in the art, usually includes an operating system, one or more application programs, other program modules, and program data. A user may enter commands and information into the computer through keyboard, touch screen, pointing device, a script containing computer program code written in a scripting language or other input devices (not shown), such as a microphone, etc. These and other input devices are often connected to the processing unit through known electrical, optical, or wireless connections.

The computer that effects many aspects of the described processes will typically operate in a networked environment using logical connections to one or more remote computers or data sources, which are described further below. Remote computers may be another personal computer, a server, a router, a network PC, a peer device or other common network node, and typically include many or all of the elements described above relative to the main computer system in which the inventions are embodied. The logical connections between computers include a local area network (LAN), a wide area network (WAN), virtual networks (WAN or LAN), and wireless LANs (WLAN) that are presented here by way of example and not limitation. Such networking environments are commonplace in office-wide or enterprise-wide computer networks, intranets, and the Internet.

When used in a LAN or WLAN networking environment, a computer system implementing aspects of the invention is connected to the local network through a network interface or adapter. When used in a WAN or WLAN networking environment, the computer may include a modem, a wireless link, or other mechanisms for establishing communications over the wide area network, such as the Internet. In a networked environment, program modules depicted relative to the computer, or portions thereof, may be stored in a remote data storage device. It will be appreciated that the network connections described or shown are exemplary and other mechanisms of establishing communications over wide area networks or the Internet may be used.

While various aspects have been described in the context of a preferred embodiment, additional aspects, features, and methodologies of the claimed inventions will be readily discernible from the description herein, by those of ordinary skill in the art. Many embodiments and adaptations of the disclosure and claimed inventions other than those herein described, as well as many variations, modifications, and equivalent arrangements and methodologies, will be apparent from or reasonably suggested by the disclosure and the foregoing description thereof, without departing from the substance or scope of the claims. Furthermore, any sequence(s) and/or temporal order of steps of various processes described and claimed herein are those considered to be the best mode contemplated for carrying out the claimed inventions. It should also be understood that, although steps of various processes may be shown and described as being in a preferred sequence or temporal order, the steps of any such processes are not limited to being carried out in any particular sequence or order, absent a specific indication of such to achieve a particular intended result. In most cases, the steps of such processes may be carried out in a variety of different sequences and orders, while still falling within the scope of the claimed inventions. In addition, some steps may be carried out simultaneously, contemporaneously, or in synchronization with other steps.

The embodiments were chosen and described in order to explain the principles of the claimed inventions and their practical application so as to enable others skilled in the art to utilize the inventions and various embodiments and with various modifications as are suited to the particular use contemplated. Alternative embodiments will become apparent to those skilled in the art to which the claimed inventions pertain without departing from their spirit and scope. Accordingly, the scope of the claimed inventions is defined by the appended claims rather than the foregoing description and the exemplary embodiments described therein.

What is claimed is:

1. A method, comprising the steps of:
receiving a request from a particular electronic device to contact a particular type of user of another electronic device, wherein the request comprises one or more electronic data items that define criteria for identifying the particular type of user;
comparing the one or more electronic data items to one or more user profiles associated with system users to identify one or more system users whose profiles match, at least in part, the criteria defined in the request and the particular type of user;
retrieving connection information for each of the identified one or more users, wherein the connection information comprises an availability for contact for each of the identified one or more users and contact information associated with each of the identified one or more users;
determining, based on the connection information, a specific user to contact; and
establishing a connection, based on the contact information, between the particular electronic device and an electronic device of the specific user.

2. The method of claim 1, further comprising the steps of:
requesting one or more electronic location data items corresponding to the physical location of the particular electronic device;
receiving the one or more electronic location data items;
determining, based on the received one or more electronic location data items, the physical location of the particular electronic device;
transmitting, based on the contact information, the physical location of the particular electronic device to the electronic device of the specific user.

3. The method of claim 2, wherein the one or more electronic location data items further comprise two or more electronic location data items corresponding to the physical location of the particular electronic device.

4. The method of claim 1, further comprising the steps of:
receiving, as part of the connection, one or more electronic message data items corresponding to a message for the specific user;
storing the one or more electronic message data items until receipt of a request from the specific user;
transmitting, based on the contact information, the one or more electronic message data items to the electronic device of the specific user.

5. The method of claim 1, wherein the identity of the specific user is unbeknownst to the particular electronic device prior to receiving the request.

6. The method of claim 1, wherein the criteria for identifying the particular type of user and the one or more user profiles further comprise physical location data that matches.

7. The method of claim 1, wherein the criteria for identifying the particular type of user further comprise one or more role parameters and the one or more user profiles further comprise one or more roles that match the one or more role parameters.

8. The method of claim 7, wherein the criteria for identifying the particular type of user further comprise an affinity for a subject matter and the one or more roles further comprise the subject matter.

9. The method of claim 7, wherein the one or more roles are defined based on movement of electronic devices.

10. The method of claim 9, wherein each of the one or more roles corresponds to a particular pattern of movement of electronic devices.

11. The method of claim 10, wherein the particular pattern of movement of electronic devices corresponds to a defined time period.

12. The method of claim 1, wherein determining, based on the connection information, a specific user to contact is further based on a priority of the identified one or more users defined by one or more predefined rules.

13. The method of claim 1, wherein the connection is of a predefined type defined by the request, the contact information, or the one or more user profiles.

14. A system, comprising:
a first electronic device that generates a request to contact a particular type of user of another electronic device, wherein the request comprises one or more electronic data items that define criteria for identifying the particular type of user, and transmits that request to a server;
the server that receives that request from the first electronic device, wherein the server compares the one or more electronic data items to one or more user profiles associated with system users to identify one or more system users whose profiles match, at least in part, the criteria defined in the request and the particular type of user, generates a request for connection information regarding the identified one or more users, and transmits the request for connection information to a database;
the database that receives the request for connection information from the server, wherein the database transmits, to the server, the connection information regarding the identified one or more users that comprises an availability for contact for each of the identified one or more users and contact information associated with each of the identified one or more users;
the server that receives the connection information from the database, wherein the server determines, based on the connection information, a specific user to contact and establishes a connection, based on the contact information, between the first electronic device and a second electronic device corresponding to the specific user; and
the second electronic device that connects with the first electronic device.

15. The system of claim 14, wherein the server, as part of the connection:
receives, from the first electronic device, one or more electronic message data items corresponding to a message for the specific user; and
stores the one or more electronic message data items, in the database, until receipt of a request from the specific user;
retrieves, upon receipt of the request from the specific user, the one or more electronic message data items from the database; and
transmits, based on the contact information, the one or more electronic message data items to the second electronic device.

16. The system of claim 14, wherein the identity of the specific user is unbeknownst to the first electronic device prior to generating the request.

17. The system of claim 14, wherein the criteria for identifying the particular type of user and the one or more user profiles further comprise physical location data that matches.

18. The system of claim 14, wherein the criteria for identifying the particular type of user further comprise one or more role parameters and the one or more user profiles further comprise one or more roles that match the one or more role parameters.

19. The system of claim 18, wherein the criteria for identifying the particular type of user further comprise an affinity for a subject matter and the one or more roles further comprise the subject matter.

20. The system of claim 18, wherein the one or more roles are defined based on movement of electronic devices.

21. The system of claim 20, wherein each of the one or more roles corresponds to a particular pattern of movement of electronic devices.

22. The system of claim 21, wherein the particular pattern of movement of electronic devices corresponds to a defined time period.

23. The system of claim 14, wherein determining, based on the connection information, a specific user to contact is further based on a priority of the identified one or more users defined by one or more predefined rules.

24. The system of claim 14, wherein the connection is of a predefined type defined by the request, the contact information, or the one or more user profiles.

25. A method, comprising the steps of:
receiving location data from a particular electronic device, the location data defining one or more physical locations of the particular electronic device over a defined time period;
comparing the received location data to one or more predefined rules, wherein the one or more predefined rules define one or more roles based on movement or non-movement of the particular electronic device as defined by the one or more physical locations of the particular electronic device over the defined time period;
determining one or more roles corresponding to the particular electronic device; and
associating the particular electronic device with the one or more determined roles.

26. The method of claim 25, further comprising the steps of:
receiving communication data regarding one or more electronic devices associated with the one or more determined roles, wherein the communication data regarding the one or more electronic devices comprises communication data regarding the particular electronic device;
comparing the communication data regarding the particular electronic device with the communication data regarding the one or more electronic devices; and
determining, based on the comparison, a relative amount of communication of the particular electronic device.

27. The method of claim 25, wherein the particular electronic device comprises a first electronic device, further comprising the steps of:
receiving a request from a second electronic device to contact a user associated with the one or more determined roles, wherein the request comprises one or more electronic data items that identify the one or more determined roles;
comparing the one or more electronic data items to one or more predefined communication rules, wherein the one or more predefined communication rules define a priority of the one or more determined roles and one or more users corresponding to each of the one or more determined roles, wherein the one or more users comprise a user of the first electronic device;
determining, based on the comparison, to contact the user of the first electronic device;
retrieving connection information regarding the user of the first electronic device, wherein the connection information comprises contact information for the first electronic computing device;
establishing a connection, based on the contact information, between the second electronic device and the first electronic device.

28. A system, comprising:
an electronic device that gathers location data, wherein the location data comprises data defining one or more physical locations of the electronic device over a defined time period, and transmits the location data to a server; and
the server that receives the location data from the electronic device, wherein the server compares the location data to one or more predefined rules that define one or more roles based on movement or non-movement of the electronic device as defined by the one or more physical locations of the electronic device over the defined time period, determines one or more roles corresponding to the electronic device, and associates the electronic device with the one or more determined roles.

29. The system of claim 28, wherein the server:
receives communication data regarding one or more electronic devices associated with the one or more determined roles, wherein the communication data regarding the one or more electronic devices comprises communication data regarding the electronic device;
compares the communication data regarding the electronic device with the communication data regarding the one or more electronic devices; and
determines, based on the comparison, a relative amount of communication of the electronic device.

30. The system of claim 28, wherein the electronic device comprises a first electronic device, further comprising:
a second electronic device that generates a request to contact a user associated with the one or more determined roles, wherein the request comprises one or more electronic data items that identify the one or more determined roles, and transmits the request to the server;
the server that receives the request from the second electronic device, wherein the server:
compares the one or more electronic data items to one or more predefined communication rules, wherein the one or more predefined communication rules define a priority of the one or more determined roles and one or more users corresponding to each of the one or more determined roles, wherein the one or more users comprise a user of the first electronic device;
determines, based on the comparison, to contact the user of the first electronic device;
retrieves connection information regarding the user of the first electronic device, wherein the connection information comprises contact information for the first electronic computing device; and
establishes a connection, based on the contact information, between the second electronic device and the first electronic device; and
the second electronic device that connects with the first electronic device.
